(19) United States
(12) Patent Application Publication
(10) Pub. No.: US 2004/0189896 A1
(43) Pub. Date: Sep. 30, 2004

(54) Method for manufacturing transflective thin film transistor (TFT) liquid crystal display (LCD)

(76) Inventors: Jin Hui Cho, Kyoungki-do (KR); Seung Moo Rim, Kyoungki-do (KR); Hyun Jin Kim, Kyoungki-do (KR); Kyoung Seok Son, Seoul (KR)

Correspondence Address: LADAS & PARRY, 224 SOUTH MICHIGAN AVENUE, SUITE 1200, CHICAGO, IL, 60604, US

(21) Appl. No.: 10/713,883

(22) Filed: Nov. 14, 2003

(30) Foreign Application Priority Data
Mar. 27, 2003 (KR) 2003-19173

(51) Int. Cl. G02F 1/1335

(52) U.S. Cl. 349/113

(57) ABSTRACT

The present invention relates to a method for manufacturing a transflective thin film transistor liquid crystal display, which comprises the steps of: forming a gate electrode on an insulating substrate; forming a gate insulating film on the insulating substrate including the gate electrode; forming an active layer and an ohmic contact layer on the gate insulating film; forming source/drain electrodes on the insulating substrate including the active and ohmic contact layers in such a manner that the source/drain electrodes overlap with the ohmic contact layer; forming a protective film on the insulating substrate including the source/drain electrodes; forming a resin layer on the protective film; exposing the resin layer to light through one mask, so that a contact hole is formed at one region of the resin layer, and concave/convex portions having the desired concave/convex portions are formed on the other region of the resin layer; and forming a reflective electrode on the entire upper surface of the resulting substrate including the contact hole and the concave/convex portions.

### BACKGROUND OF THE INVENTION

1. Field of the Invention

The present invention relates to a method for manufacturing a transflective thin film transistor (TFT) liquid crystal display (LCD). More particularly, the present invention relates to a method for manufacturing a transflective thin film transistor (TFT) liquid crystal display (LCD), which allows a contact hole and concave/convex portions as micro-lens to be formed at the same time by an one-step exposure process using one mask.

2. Description of the Prior Art

Generally, liquid crystal displays are divided into various modes, particularly a reflective mode and a transmissive mode according to the position of a light source.

The reflective liquid crystal display devices have no light source therein and show images using incident light from the external. For this purpose, metals having high reflectivity are used for a reflector sheet or a pixel electrode.

On the other hand, the transmissive liquid crystal display devices show images by a backlight unit mounted on the backside thereof. To increase the light transmission of the backlight unit, transparent oxide having high transmissivity, such as indium tin oxide (ITO) or indium zinc oxide (IZO), etc., are used for a pixel electrode.

In addition, there are transflective liquid crystal displays of simultaneously embodying the reflective and transmissive modes. In comparison with the transmissive liquid crystal display, the reflective or transflective liquid crystal display is advantageous in that it is driven at low electrical power, and does not require a backlight unit (but the transflective LCD requires the backlight unit) so that it has thin thickness and light weight. Also, it has excellent display characteristics at the outdoors and thus is favorable for portable devices.

However, the reflective or transflective liquid crystal display is not substantially put to practical use in spite of demands in a liquid crystal panel market. This is because it does not satisfy the market demand in view of brightness, contrast ratio and response speed.

Generally, in the transflective liquid crystal display, a transmissive pixel electrode made of transparent oxide, such as ITO or IZO, is formed in such a manner as to be connected with a source electrode disposed at a lower portion thereof in a process of forming electrodes on a TFT-side substrate. Then, a protective film, such as a SiNₓ film, is deposited on the resulting structure, and a contact hole is formed in the protective film.

Next, a metal layer is deposited on the resulting structure including the contact hole, and patterned to form a reflective pixel electrode, which is connected with the source electrode through the contact hole.

In this case, on the protective film, micro-lenses serving to condense reflective light may be formed in a concave/convex shape. In order to make the formation of this concave/convex micro-lenses smooth, the micro-lenses are formed of an organic insulating film.

Such concave/convex micro-lenses are a core technology of improving brightness, which is most problematic in the reflective or transflective liquid crystal display.

In the prior art, two shapes, i.e., a contact hole and concave/convex micro-lenses are formed by a one-step exposure process with one mask. This exposure process is conducted at an exposure dose focusing the formation of the contact hole. This is because an organic insulating film (i.e., a resin film) remains below the contact hole even after patterning if an exposure dose larger than a given level is not applied, although the concave/convex micro-lenses show some optical characteristics once they are roughly formed. The organic insulating film remaining in the contact hole contributes to interfere with the transmission of an electrical signal from a data line to a pixel electrode, such that liquid crystal molecules cannot be driven.

Thus, the optimum exposure dose required to form the concave/convex micro-lenses is about 30-40% of the exposure dose required to form the contact hole. If the exposure process is carried out at a higher exposure dose than this optimum exposure dose, the concave/convex angles of the concave/convex portions will be unavoidably increased.

Thus, the exposure process focusing the formation of the contact hole as described above has a problem in that it is difficult to form concave/concave micro-lenses having the desired concave/convex angles so that an improvement in optical characteristics is limited.

### SUMMARY OF THE INVENTION

Accordingly, the present invention has been made to solve the above-mentioned problems occurring in the prior art, and an object of the present invention is to provide a method for manufacturing a transflective thin film transistor liquid crystal display, in which the one-step exposure process using one mask is conducted at an exposure does focusing the formation of concave/convex portions as micro-lenses, so that the concave/convex portions having the desired concave/convex angles can be formed, and a portion of an organic insulating film does not remain below a contact hole, thereby reducing the manufacturing cost of the liquid crystal display and improving the optical characteristics of the liquid crystal display.

To achieve the above object, the present invention provides a method for manufacturing a transflective thin film transistor liquid crystal display, which comprises the steps of: forming a gate electrode on an insulating substrate; forming a gate insulating film on the insulating substrate including the gate electrode; forming an active layer and an ohmic contact layer on the gate insulating film; forming a source/drain electrode on the insulating substrate including the active and ohmic contact layers in such a manner that the source/drain electrode overlaps with the ohmic contact layer; forming a protective film on the insulating substrate including the source/drain electrode; forming a resin layer on the protective film; exposing the resin layer to light through one mask, so that a contact hole is formed at one region of the resin layer, and concave/convex portions with the desired concave/convex angles are formed on the other region of the resin layer; and forming a reflective electrode on the entire upper surface of the resulting substrate including the contact hole and the concave/convex portions

### BRIEF DESCRIPTION OF THE DRAWINGS

The above and other objects, features and advantages of the present invention will be more apparent from the following detailed description taken in conjunction with the accompanying drawings, in which:

FIGS. 1a to 1e are cross-sectional views showing a transflective thin film transistor liquid crystal display according to a first embodiment of the present invention;

FIGS. 2a to 2e are cross-sectional views showing a transflective thin film transistor liquid crystal display according to a second embodiment of the present invention;

FIGS. 3a to 3d are cross-sectional views showing a transflective thin film transistor liquid crystal display according to a third embodiment of the present invention; and

FIGS. 4a to 4c show that fan-shaped concave/convex portions are formed in pixels in various manners according to the present invention.

### DETAILED DESCRIPTION OF THE PREFERRED EMBODIMENTS

A manufacturing method of a liquid crystal display according to the present invention is the same as the prior art except for steps conducted before the step of forming an organic insulating film (resin film). Thus, a detailed description of such prior steps will be avoided.

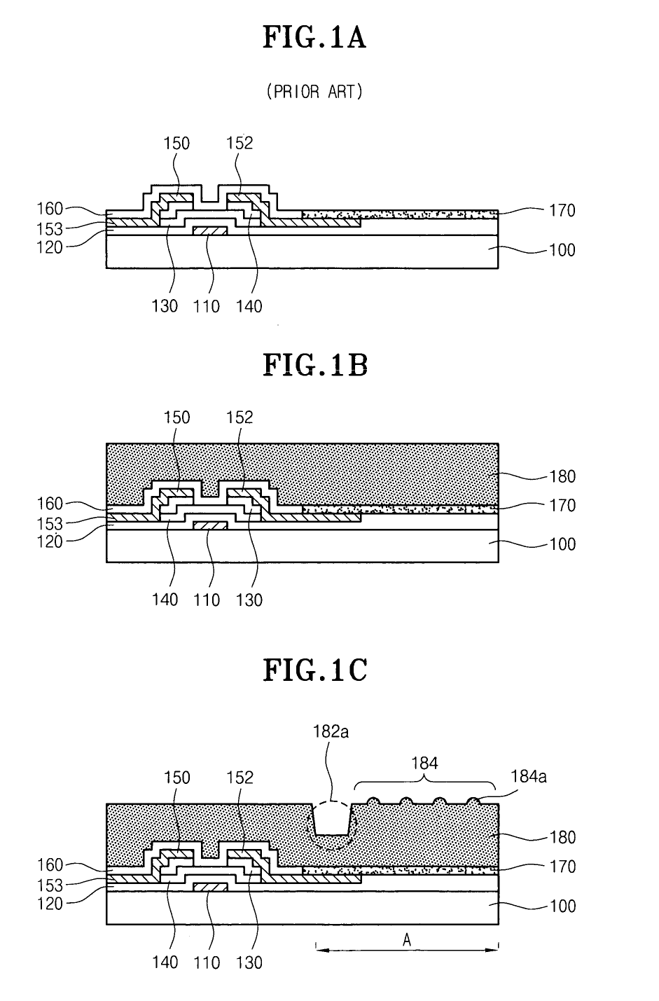

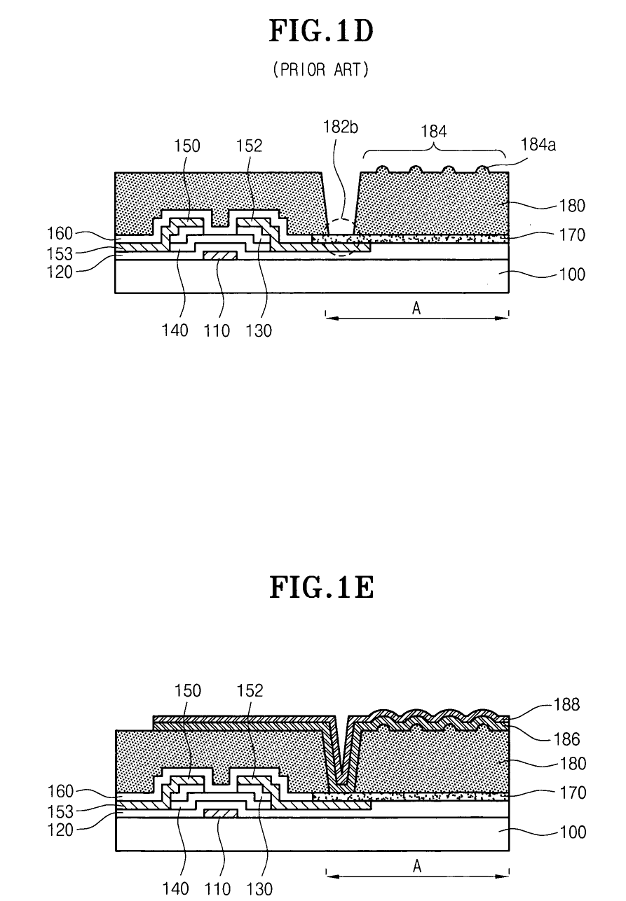

FIGS. 1a to 1e are cross-sectional views showing a method for manufacturing a transflective thin film transistor liquid crystal display according to the present invention.

As shown in FIG. 1a, a thin film transistor consisting of a gate electrode 110, a gate insulating film 120, an active layer 130, an ohmic contact layer 140 and source/drain electrodes 150 and 152 is formed on a glass substrate 100. Then, a data line 153, which extends from the source/drain electrodes and has a data pad (not shown) at an end, is formed on the substrate.

Next, a protective film 160 is formed on the source/drain electrodes 150 and 152, and then patterned to partially expose the upper surface of each of the drain electrode 152 and the gate insulating film 120.

A transparent electrode made of a material, such as ITO (indium tin oxide), is formed on the exposed portions of the drain electrode 152 and the gate electrode 120. In this case, the transparent electrode 170 is formed only at a transflective liquid crystal display.

As shown in FIG. 1b, on the entire upper surface of the substrate including the patterned transparent electrode 170, there is then formed an organic insulating film 180 in which concave/convex portions can be easily formed. After this, the organic insulating film 180 is exposed to light by a one-step exposure process using one mask, thereby forming a contact hole 182a and concave/convex portions 184 as shown in FIG. 1c. At this time, since the concave/convex angles of the concave/convex portions forming with the glass substrate 100 varies depending on the mask pattern and exposure dose, which is applied during the exposure process, the desired concave/convex angles of the concave/convex portions are obtained by the adjustment of exposure dose. In other words, a portion of the organic insulating film 180 where the concave/convex potions are formed is exposed to light at a lower exposure dose than an exposure dose required for forming the contact hole, so that the concave/convex portions 184 with the desired concave/convex angles are obtained. At this time, the one-step exposure process using one mask is conducted at an exposure dose focusing the formation of the concave/convex portions, so that a portion of the organic insulating film 180 remains below the contact hole 182a while the concave/convex portions 184 having the desired concave/convex angles are formed in a reflective region of the organic insulating film 180. For example, in order to form the contact hole 182a by exposing the entire organic insulating film having a thickness of 2.5 μm to light, there is required an exposure dose of 320 mJ/cm². According to the present invention, if the organic insulating film 182 is exposed to light at an exposure dose of 80-120 mJ/cm² corresponding to 30-40% of an exposure dose required to form the contact hole 182a, a portion of the organic insulating film 180 will remain below the contact hole 182 while the concave/convex portions with the desired concave/convex angles will be formed. If the organic insulating film having a thickness of 2.5 μm is exposed to light at an exposure dose of 100 mJ/cm², the thickness of a portion of the organic insulating film 180 remaining below the contact hole 182a will be about 1 μm, although it will vary depending on the kind of a developer and developing time.

Furthermore, to maximize the reflective efficiency of the concave/convex portions 184, the concave/convex portions 184 are formed such that the concave/convex angles of the concave/convex portions forming with the glass surface 100 has a Gaussian distribution with a peak value of 4-8°.

A portion of the organic insulating film 180 remaining below the contact hole 182a will interfere with the electrical conduction between a reflective electrode 186 and the transparent electrode 170. Thus, a portion of the organic insulating film remaining below the contact hole 182a is removed so that the electrical conduction between the reflective electrode 186 and the transparent electrode 170 is made smooth.

Hereinafter, a process for removing a portion of the organic insulating film remaining below the contact hole 182a, and subsequent processes, will be described.

As shown in FIG. 1c, as the size of the contact hole 182a becomes larger, the thickness of a portion of the organic insulating film 180 remaining below the contact hole 182 becomes smaller so that this remaining film portion can be easily removed. For this reason, the one-step exposure process using one mask is conducted in such a manner that the size of the contact hole 182a becomes larger.

Then, as shown in FIG. 1d, the resulting substrate is subjected to backside exposure for a sufficient period of time so that the organic insulating film remaining below the contact hole 182a is completely removed to form a contact hole 182b. By this contact hole 182b, the transparent electrode 170 can come in contact with a reflective electrode 186 to be formed in subsequent processes. Furthermore, this backside exposure is conducted only on a portion of the organic insulating film 180 having no metal layer so that the concave/convex portions 184 are prevented from being additionally exposed to light through a storage capacitor electrode.

Then, as shown in FIG. 1e, a buffer layer 186a and a reflective electrode 186b are successively formed over the entire organic insulating film 180 including the contact hole 182 and the concave/convex portions 184.

At this time, the buffer layer 186a is formed of molybdenum (Mo) or like. The reflective electrode 186b serves to reflect light from an external light source and to drive liquid crystal molecules, and is formed of a conductive metal material selected from the group consisting of aluminum and aluminum alloys (e.g., AlNd), which have excellent reflectivity and low resistance.

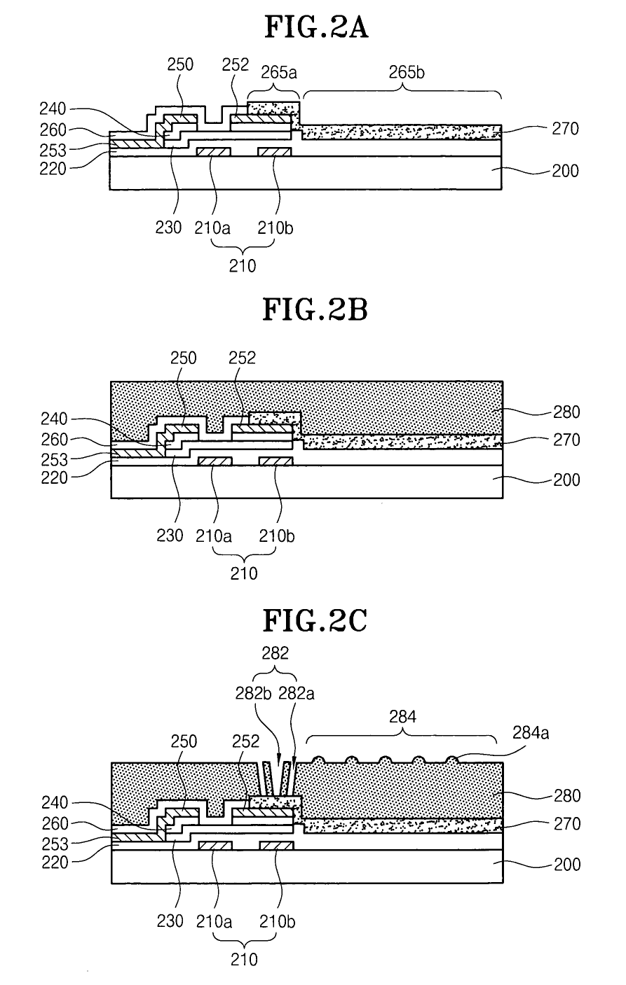

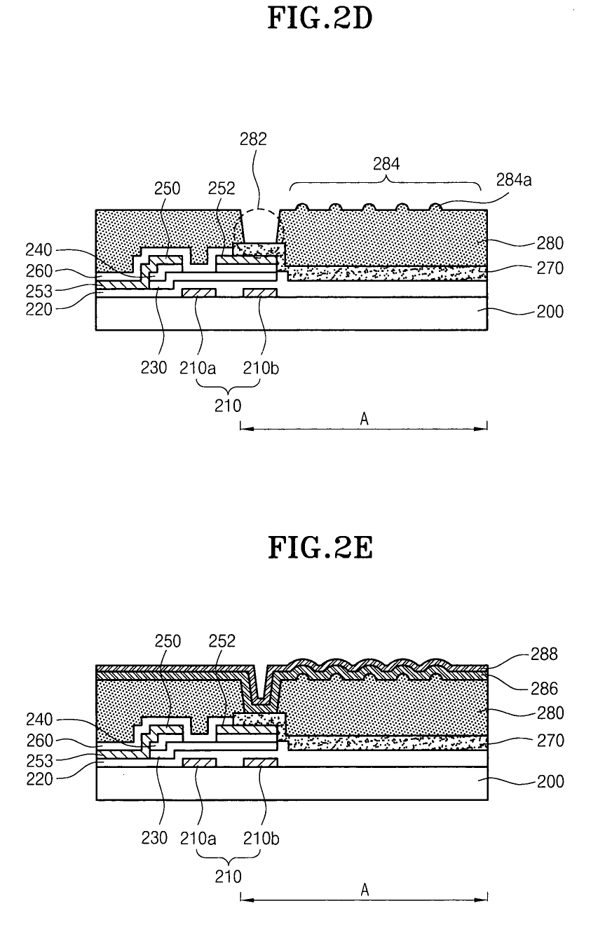

FIGS. 2a to 2e are cross-sectional views showing a method for manufacturing a transflective thin film transistor liquid crystal display according to a second embodiment of the present invention. Hereinafter, the second embodiment of the present invention will be described with reference to FIGS. 2a to 2d.

A duplicate description of the same elements as described in the first embodiment will be avoided for convenience.

In FIGS. 2a to 2e, the reference numeral 200 designates a glass substrate, 210a and 210b first and second gate electrodes, 220 a gate insulating film, 230 an active layer, 240 an ohmic contact layer, 250 and 252 source/drain electrodes, 253 a data line, 260 a protective film (SiNₓ), and 270 a transparent elecrode.

As shown in FIG. 2a, the second gate electrode 210b, the gate insulating film 220, the active layer 230, the ohmic contact layer 240 and the source electrode 252 are successively deposited on a region 265a where a contact hole will be formed. Thus, the step height of the contact hole-forming region 265a is greater than a region 265b where concave/convex portions will be formed.

To make this step height difference, the portion of a thin film transistor and wirings, which is disposed below the contact hole, has a three-layered structure including an interlayer insulating film and aluminum-based metal, and the portion of a storage capacitor is formed of only an interlayer insulating film or only chrome or molybdenum metal. Thus, the step height of the contact hole-forming region differs from that of the concave/convex portions-forming regions 265b by more than 1 μm.

Then, the protective film 260 is formed on the source/drain electrodes 252 and 250 and patterned to partially expose the upper surface of each of the source electrode 252 and the gate electrode 220.

Next, on the entire surface of the contact hole-forming region 265a including the partially exposed source electrode 252, and the concave/convex portions-forming region 265b including the exposed gate insulating film 220, a transparent electrode 270 made of ITO (indium tin oxide) or the like is formed and patterned. In this case, the transparent electrode 270 is formed only in a transflective liquid crystal display.

Then, as shown in FIG. 2b, on the entire upper surface of the resulting substrate including the patterned transparent electrode, there is applied an organic insulating film 280 in which concave/convex portions can be easily formed. The step height of a portion of the organic insulating film 280 formed on the contact hole-forming region 265a differs from that of a portion of the organic insulating film 280 formed on the concave/convex portions-forming region by more than 1 μm.

Thus, a portion of the organic insulating film 280 on the contact hole-forming region 265a is formed to a greater thickness than a portion of the organic insulating film 280 formed on the concave/convex portions-forming region 265b.

Then, as shown in FIGS. 2c and 2d, the organic insulating film 280 is subjected to a one-step exposure process using one mask. The one-step exposure process is conducted at an exposure dose focusing the formation of concave/convex portions, so that concave/convex portions having the desired concave/convex angles can be formed while a contact hole 282 is formed in the contact hole-forming region 265a.

The thickness of a portion of the organic insulating film formed on the contact hole-forming region 265a is smaller than the thickness of a portion of the organic insulating film formed on the concave/convex portions-forming region 265b. Thus, even if the organic insulating film 280 is exposed to light at an exposure dose focusing the formation of the concave/convex portions, a portion of the organic insulating film 280 formed on the contact hole-forming region 265a is sufficiently removed so that the transparent electrode 270 can be exposed through the contact hole.

Furthermore, if a portion of the protective film 260 located below the concave/convex portions 284 is completely removed, the organic insulating film 280 where a difference in step height between the contact hole-forming region 265a and the concave/convex portions-forming region 265b is 4,000 Å can be formed in a more safe manner.

Meanwhile, the shape of the contact hole 282 formed in the organic insulating film 280 is important in forming the contact hole. In other words, if a central contact hole 282a and a parasitic contact hole 282b are formed in the organic insulating film 280, a portion of the organic insulating film 280 formed at the contact hole-forming region 265a will be removed in larger amounts so that the contact hole can be easily formed.

Then, as shown in FIG. 2e, a buffer layer 286a and a reflective electrode 286b are successively formed on the entire upper surface of the organic insulating film 280 including the contact hole 282 and the concave/convex portions 284.

Through this contact hole, the reflective electrode 286b comes in contact with the source electrode 252 or the transparent electrode 270 at a width of 3-5 μm.

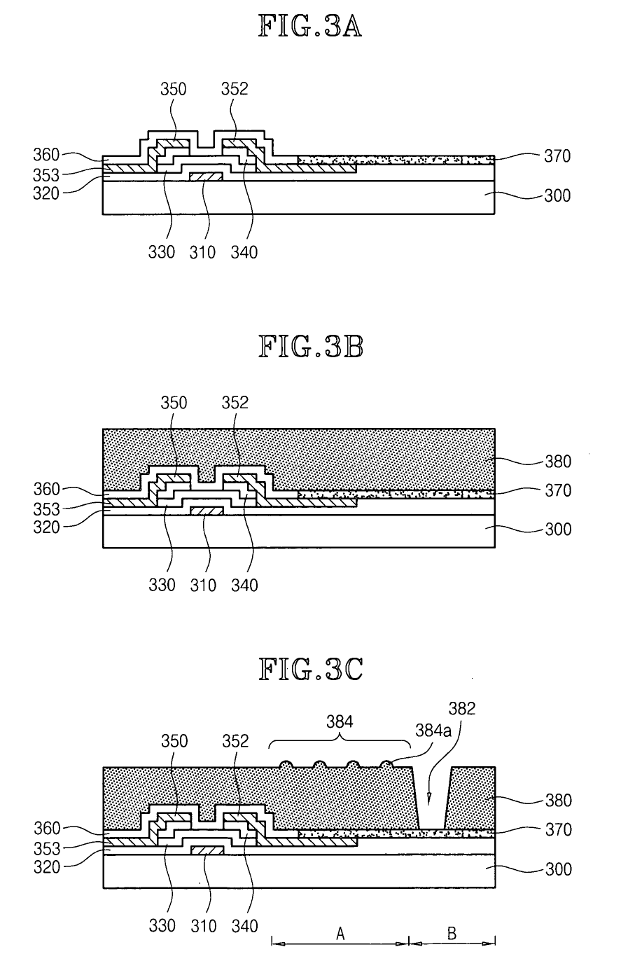

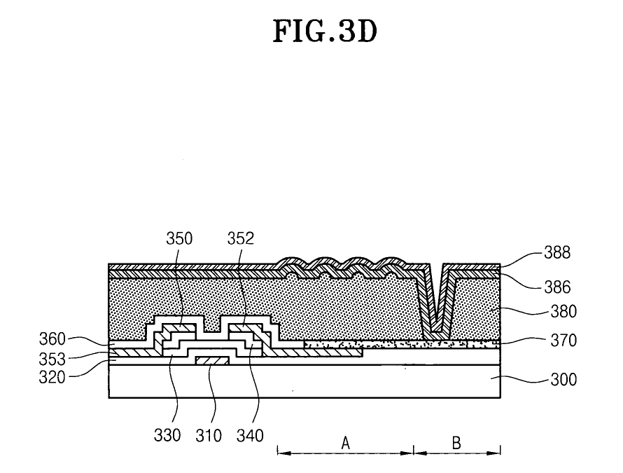

FIGS. 3a to 3d are cross-sectional views for illustrating a method for manufacturing a dual mode reflective/transmissive thin film transistor liquid crystal display according to a third embodiment of the present invention. Hereinafter, the third embodiment of the present invention will be described with reference to FIGS. 3a to 3d.

A description of the same elements as described in the first embodiment will be avoided for convenience, and only a process of removing the organic insulating film will be described.

In FIGS. 3a to 3d, the reference numeral 300 designates a glass substrate, 310 a gate electrode, 320 a gate insulating film, 330 an active layer, 340 an ohmic contact layer, 350 and 352 source/drain electrodes, 353 a data line, 360 a protective film (SiNₓ), and 370 a transparent electrode. The transparent electrode 370 is formed only in a transflective liquid crystal display.

The third embodiment of the present invention particularly relates to a transflective liquid crystal display in which a transmissive region B and a contact hole 382 are formed at the same time.

Generally, even if an organic insulating film is exposed to light at low exposure dose in forming a contact hole, forming the contact hole having a larger size allows a transparent electrode to be exposed through the contact hole.

In the prior art, however, since there is a limitation in enlarging the size of a contact hole, an organic insulating film remains below the contact hole while the size of a transparent region can be sufficiently increased. Thus, the organic insulating film does not remain at the transparent region even if the transparent region is exposed to light at the same exposure dose as that of the contact hole.

In other words, in a transflective liquid crystal display according to the present invention, the contact hole and the transmissive region are formed separately if a transparent electrode below the organic insulating film is connected with a reflective electrode above the organic insulating film.

However, the contact hole and the via hole do not need to be present separately, and any contact problem is not caused even if the transparent electrode is connected only with the reflective electrode at the via hole region.

Thus, according to the present invention, the one-step exposure process using one mask is conducted at an exposure dose focusing the formation of the concave/convex portions. In this exposure process, if the contact hole 382 is formed as large as the transparent region B so that the contact hole 382 and the transparent region B are formed to the same size at the same position, the concave/convex portions having the desired concave/convex angles can be obtained by a difference in exposure area between the contact hole-forming region and the concave/convex portions-forming region (i.e., reflective region A).

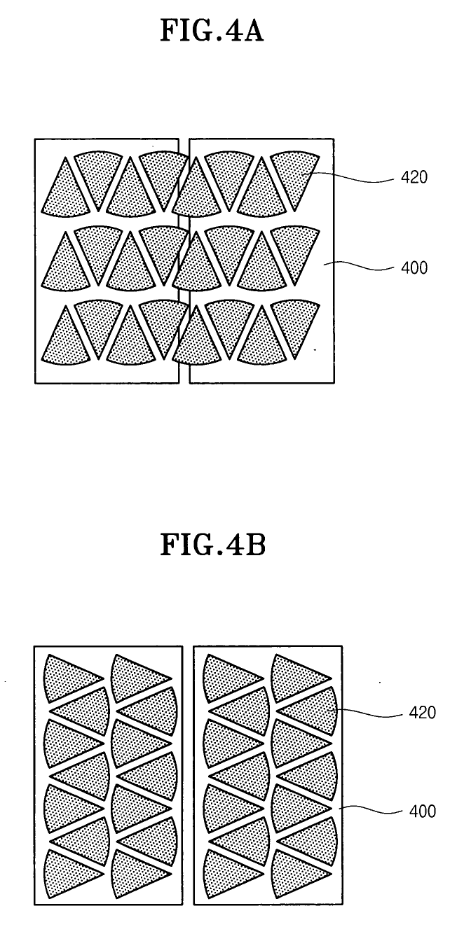

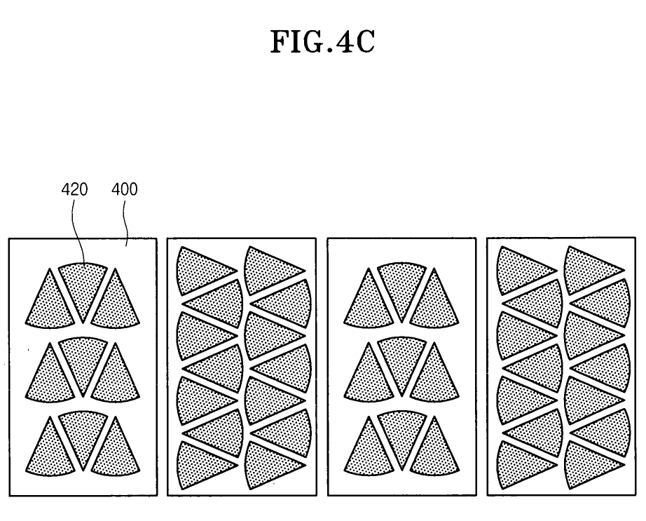

FIGS. 4a to 4c show pixels where fan-shaped concave/convex portions are formed in various manners according to the present invention.

Hereinafter, the shape of the concave/convex portions serving to improve optical characteristics, which are formed in the one-step exposure process using one mask according to the first, second and third embodiments, will be described with reference to FIGS. 4a to 4c.

In forming the concave/convex portions and the contact hole by the one-step exposure process with one mask according to the present invention, the shape of the concave/convex portions is not limited to a circular or polygonal shape which is obtained by a multi-step exposure process using plural masks according to the prior art. However, in order to make it easy to form the contact hole and the concave/convex portions, the interval between posts in the concave/convex portions needs to be maintained constantly.

In order to satisfy this requirement for the post interval, the shape of the concave/convex portions is preferably a fan or line shape, in addition to a circular or polygonal shape formed in the prior art.

Regarding the fan-shaped concave/convex portions, the optical characteristics of a liquid crystal display can be improved depending on the length of the radius, the size of the central angle, the interval between the centers and the arrangement of the fan-shaped concave/convex portions on pixels.

Concretely speaking, one fan-shaped concave/concave portion 420 can be disposed for plural pixels 400, or plural fan-shaped concave/convex portions 420 can be disposed on one pixel 400. In other words, the fan-shaped concave/convex portions 420 can be the same over all the pixels 400, or they can be the same for four or nine pixels 400. The configuration of such same pixels can be modified in such a manner that the optical characteristics of a liquid crystal display are improved.

Such fan-shaped concave/convex portions 420 have preferably a radius of 3-6 μm, and more preferably 5 μm.

Furthermore, the fan-shaped concave/convex portions have preferably a central angle of 10-180°, and more preferably 45-180°. In addition, to adjust reflectivity to an intended level, the central angle is 45-90°, and preferably about 60°.

Also, if one concave/convex portion is disposed on plural pixels, the interval between the centers of the fan-shaped concave/convex portions will be more than 200 μm. However, if plural concave/convex portions are disposed on one pixel, they will be divided into two groups of concave/convex portions consisting of a first group where the interval between centers is 0-3 μm, and a second group where the interval between centers is 8-12 μm.

As shown in FIG. 4c, the fan-shaped concave/convex portions 420 can be disposed on the pixels 400 in various manners.

Since the fan-shaped concave/convex portions as described above have both curved and linear shapes in one post unlike a circular or polygonal shape formed in the prior art, there is an advantage in that the concave/convex portions 420 having various concave/convex angles can be formed in only one separate shape. Also, they have relatively large post width, and thus, there is an advantage in that it is easy to distinguish a transmissive region from a reflective region in manufacturing a transflective liquid crystal display.

Regarding line-shaped concave/convex portions (not shown), a smaller line width makes the desired design of the concave/convex portions easy but is difficult to be applied in an actual process. In other words, a line width of less than 2 μm and an interval between lines of less than 2 μm are not difficult to be applied with an exposure system for the manufacturing of a liquid crystal display having a resolution of generally 3-4 μm.

On the other hand, if line width is larger than 5 μm, there will be a problem in that portions having a slope angle of 0° are greatly increased, and thus, reflective efficiency are rapidly reduced.

Accordingly, in order to make the application of the exposure system for liquid crystal displays possible and to prevent the problem of the rapid reduction of reflective efficiency, the line-shaped concave/convex portions, which are formed according to the present invention, preferably have a line width of 2-5 μm.

Such line-shaped concave/convex portions are advantageous in that they make the design of post width easy, and thus, allows the contact hole to be easily formed.

As described above, according to the present invention, the concave/convex portions having the desired concave/convex angles are formed by the one-step exposure process using one mask, and the organic insulating film does not remain below the contact hole. Thus, the present invention has the effects of reducing the manufacturing costs of a liquid crystal display and allowing the reduction of reflective efficiency caused by mismatch of the concave/convex portions to be prevented, thereby improving the optical characteristics of the liquid crystal display.

Furthermore, the fan-shaped concave/convex portions formed according to the present invention have both curved and linear shapes in one post, and thus, have the effect of allowing the concave/convex portions having various concave/convex angles to be formed in only one separate shape. In addition, the fan-shaped concave/convex portions have a relatively large post width, and thus, have the effect of making it easy to distinguish a reflective region from a transmissive region in manufacturing a transflective liquid crystal display.

Finally, the line-shaped concave/convex portions, which are formed according to the present invention, have the effect of making the design of post width easy, and thus, allowing the contact hole to be more easily formed.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method for manufacturing a transflective thin film transistor liquid crystal display, which comprises the steps of:
forming a gate electrode on an insulating substrate;
forming a gate insulating film on the insulating substrate including the gate electrode;
forming an active layer and an ohmic contact layer on the gate insulating film;
forming source/drain electrodes on the insulating substrate including the active and ohmic contact layers in such a manner that the source/drain electrodes overlap with the ohmic contact layer;
forming a protective film on the insulating substrate including the source/drain electrodes;
forming a resin layer on the protective film;
exposing the resin layer to light through one mask, so that a contact hole is formed at one region of the resin layer, and concave/convex portions having the desired concave/convex portions are formed on the other region of the resin layer; and
forming a reflective electrode on the entire upper surface of the resulting substrate including the contact hole and the concave/convex portions.

2. The method of claim 1, which additionally comprises the step of subjecting the resin layer to backside exposure to remove a portion of the resin layer remaining below the contact hole, after the step of exposing the resin layer to light.

3. The method of claim 1, which additionally comprises the steps of partially removing the protective film and then forming a transparent electrode on the exposed portions of the drain electrode and the insulating substrate, before the step of forming the resin layer.

4. The method of claim 1, wherein the resin layer has a thickness of 1-4 μm or 2.5-3 μm.

5. The method of claim 1, wherein the concave/convex angles have a Gaussian distribution with a peak value of 4 to 6°.

6. The method of claim 2, wherein the backside exposure is conducted at an exposure dose of 350-3,500 mJ/cm².

7. The method of claim 1, wherein a region of the substrate where the contact hole is formed has a greater step height than a region of the substrate where the concave/convex portions are formed.

8. The method of claim 7, wherein the region where the contact hole is formed has a three-layered structure of the source and gate electrodes at the lower portion thereof, and the region where the concave/convex portions are formed has a single-layered structure at the lower portion thereof.

9. The method of claim 7, wherein the step height difference is lower than 1 μm.

10. The method of claim 7, wherein a portion of the resin layer where the contact hole is formed is removed upon the exposure step to expose the layer under the removed portion of the resin layer, while the concave/convex portions having the determined concave/convex angles are formed on the resin layer.

11. The method of claim 7, which additionally comprises the step of completely removing a portion of the protective layer to obtain an additional step height difference of about 4,000 Å or more.

12. The method of claim 7, wherein the contact hole formed in the organic insulating film consists of a central contact hole and a parasitic contact hole.

13. The method of claim 7, wherein the reflective electrode and the source electrode come in contact with each other at a width of 3-5 μm through the contact hole.

14. The method of claim 7, wherein the reflective electrode and the transparent electrode come in contact with each other at a width of 3-5 μm through the contact hole.

15. The method of claim 1, wherein the contact hole is formed as large as the transmissive region such that the contact hole is formed to the same size at the same position as the transmissive region.

16. The method of claim 1, wherein the concave/convex portions have a polygonal, circular, fan or linear shape.

17. The method of claim 16, wherein the concave/convex portions allow the optical characteristics of the liquid crystal display to be adjusted depending on the length of the radius thereof, the size of the central angle thereof, the interval between the centers thereof, and the arrangement thereof on pixels.

18. The method of claim 16, wherein the fan-shaped concave/convex portions are disposed on one pixel in large numbers, or on plural pixels in one number.

19. The method of claim 17, wherein the length of the radius is 3-6 μm, and the size of the central angle is 45 to 180°.

20. The method of claim 17, wherein the size of the central angle is about 60°.

21. The method of claim 17, wherein the fan-shaped concave/convex portions are disposed on one pixel in large numbers, the fan-shaped concave/convex portions being divided into two groups consisting of a first group where the interval between the centers is 0-3 μm and a second group where the interval between the centers is 8-12μm.

22. The method of claim 16, wherein the line-shaped concave/convex portions have a line width of 3-5 μm.
